(19) United States
(12) Patent Application Publication
(10) Pub. No.: US 2013/0254584 A1
(43) Pub. Date: Sep. 26, 2013

(54) SEQUENCER SYSTEM AND CONTROL METHOD THEREFOR

(71) Applicant: Morimichi Tamaoki, Chiyoda-ku (JP)

(72) Inventor: Morimichi Tamaoki, Chiyoda-ku (JP)

(73) Assignee: MITSUBISHI ELECTRIC CORPORATION, Chiyoda-ku, Tokyo (JP)

(21) Appl. No.: 13/990,501

(22) PCT Filed: Dec. 16, 2010
(86) PCT No.: PCT/JP2010/072702

§ 371 Date: May 30, 2013

(51) Int. Cl. G06F 1/12

(52) U.S. Cl. CPC G06F 1/12
USPC 713/401

(57) ABSTRACT

A sequencer system includes a plurality of units, a backplane on which the units are mounted, bus communication lines for data transmission and reception among the units, a clock generation unit that generates a fixed-cycle clock signal having an arbitrary cycle, and an electric signal line provided separately from the bus communication lines, to transfer the fixed-cycle clock signal from the clock generation unit to the units via the backplane. Each of the units includes a processor that controls the unit, and an interrupt-signal control unit that generates an interrupt signal corresponding to the fixed-cycle clock signal. The processor uses the interrupt signal to synchronize control timings of the units.

### FIELD

The present invention relates to a sequencer system including a plurality of units and the like and a control method therefor, and more particularly to a configuration and a method that realize inter-unit synchronous control from an input change timing of various I/O through a control process such as data computation and processing to an output change timing by using a simple configuration as means for contributing to performance improvement of a user system using a sequencer and the entire device.

### BACKGROUND

In recent years, sequencer systems have been widely applied with achievement of high performance and high functionality, and user's needs are varied. Under such circumstances, there are demands for additing new functions to the sequencer system and performance improvement thereof. As a user's approach for high performance and high functionality of the user system and device, an advanced control theory such as predictive control has been used for the control method using the sequencer. In connection thereto, the computation performance of a CPU that performs control computation of the sequencer system has been improved conventionally with respect to such demands. Furthermore, there is a technique of improving the performance as a sequencer system by high-speed data transmission and reception among units of a control device including a plurality of units (for example, Japanese Patent Application No. 2008-522324).

Further, there has been conventionally proposed a technique of synchronizing control processes of respective units by using a configuration including a data communication bus for synchronous control and a cycle master module that manages the communication thereof (see, for example, Patent Literature 1). By executing synchronous control by executing computation of a motion control module, triggered by reception of synchronized data from the cycle master module, loads in respective modules are reduced in a motion controller system.

Further, a technique of reliably performing data transfer among a controller and devices by using a synchronization signal has been conventionally proposed (see, for example, Patent Literature 2).

### CITATION LIST

### Patent Literatures

Patent Literature 1: Japanese Patent Application Laid-open No. 2005-293569

Patent Literature 2: Japanese Patent Application Laid-open No. 2004-86432

### SUMMARY

### Technical Problem

In the above technique described in Japanese Patent Application No. 2008-522324, the plurality of units constituting the sequencer system operate in an individual control cycle (a clock). In this case, as an issue generally common to conventional sequencer systems, there are variations in the time from an electrical change timing of an external input to an input unit (or a latch process timing of the external input in the input unit), through a control process such as computation and processing of data in a CPU unit to an electrical change timing of an external output from an output unit.

For example, as shown in FIG. 16, when a control cycle ns of an input unit, a computation cycle cs of a CPU unit, and a control cycle ss of an output unit are all different, there is a difference in times t31 and t32 from a change in the external input to a change in the external output. There is also a difference in times t33 and t34 from the latch process of the external input to the change in the external output. Therefore, it is difficult to ensure control accuracy, assuming that the time from the change in the external input to the change in the external output is constant.

Furthermore, when an operation as shown in FIG.

16 is applied to a configuration in which a plurality of input/output units are provided with respect to one CPU unit, pieces of input data latched at timings different for each unit are transferred to the CPU unit. Further, the timing at which a computation result by the CPU unit is reflected to the electrical change in the external output becomes different for each unit.

For example, as shown in FIG. 17, it is assumed that two input units (a first input unit and a second input unit) and two output units (a first output unit and a second output unit) are provided with respect to one CPU unit. A control cycle ns1 of the first input unit and a control cycle ns2 of the second input unit are different from each other. A control cycle ss1 of the first output unit and a control cycle ss2 of the second input unit are different from each other.

Input data from the first input unit (first input data) and input data from the second input unit (second input data) are input to the CPU unit, and the CPU unit outputs first output data and second output data. Pieces of input data latched at timings different for each input unit are input to the CPU unit (t35≠t36). The timings at which the result of the computation performed by the CPU unit is reflected to the electrical change in the external output become different for each output unit (t37≠t38). Therefore, there is a problem in that even if the advanced control theory such as predictive control is used in a user program processed by the CPU unit, expected results cannot be sufficiently acquired.

In the above technique described in Patent Literature 1, it is intended to realize synchronous control among modules and reduce loads in respective modules in a configuration using two buses, that is, a synchronous bus and an event bus. For example, as shown in FIGS. 3 and 4 of Patent Literature 1, when a shared bus is to be used, such control that assumes a synchronous ASIC may become necessary. Furthermore, on the shared bus, plural pieces of data cannot be handled simultaneously, and thus the synchronization cycle needs to be set long in proportion to the number of modules to be synchronized or an increase of a data amount required for synchronous control.

Regarding improvement of the performance by dividing data to be handled by the two buses (see paragraph in Patent Literature 1), it cannot be considered to be effective in view of an increase of data required in one cycle of synchronization. When there is unnecessary data for each unit, the data amount of all the units affects the synchronization cycle. As another issue, when two buses are to be used, use of a bus communication ASIC for the cycle master module or each motion module causes a cost increase and complication of the configuration.

Furthermore, in a configuration in which the cycle master module manages a synchronizing timing and uses a shared bus (see claim 1 in Patent Literature 1), another system using another cycle master module needs to be prepared in order to execute control by different synchronization cycle. Therefore, there is a problem in that synchronous control of a plurality of cycles cannot be executed in one system.

The technique described in Patent Literature 2 is a technique of solving a problem of reliably performing data transfer, in which a synchronization signal is used to synchronize processes of modules having different control cycles. As a sequence of processes at a synchronizing timing among the controller and the devices, a synchronization signal is first transmitted to devices (option modules) to be synchronized, upon completion of data input/output in the controller (a PLC module). The devices (option modules) then operate by an input of an interrupt signal generated based on the synchronization signal.

In this case, there is a problem in that the input/output process among the controller (the PLC module) and the devices (the option modules) cannot be performed simultaneously (see FIG. 4 and paragraph [0005] in Patent Literature 2). Furthermore, there is a problem in that synchronous control in which completion of the data input/output in the controller (the PLC module) is not designated as a starting point but the input or output process of the devices (the option modules) is designated as a starting point or synchronous control in which respective devices operate at an arbitrary timing in the synchronization cycle cannot be executed.

The present invention has been achieved in order to solve the above problems, and an object of the present invention is, as a configuration and a method of contributing to performance improvement of a system that uses a sequencer including a plurality of units mounted on a backplane and the entire device, to provide a sequencer system and a control method therefore that realize high-performance inter-unit synchronous control that enables coordination control from an input change timing of various I/O through a control process such as data computation and processing to an output change timing and fixed-cycle control, realize fixed cycle control, and realize synchronous control among a plurality of units in one sequencer system, by adding an inexpensive configuration to an existing sequencer system.

### Solution to Problem

To solve the above problems and achieve an object, there is provided a sequencer system according to the present invention including: a plurality of units; a backplane on which the units are mounted; a bus communication line for data transmission and reception among the units; a clock generation unit that generates a fixed-cycle clock signal having an arbitrary cycle; and an electric signal line that is provided separately from the bus communication line, and transfers the fixed-cycle clock signal from the clock generation unit to the units via the backplane, wherein each of the units includes a processor that controls the unit, and an interrupt-signal control unit that generates an interrupt signal corresponding to the fixed-cycle clock signal, and the processor uses the interrupt signal to synchronize control timings of the units.

### Advantageous Effects of Invention

The sequencer system and the control method therefor according to the present invention realize high-performance inter-unit synchronous control and realize a multiple types of synchronous control in one sequencer system, by adding an inexpensive configuration to an existing sequencer system.

### BRIEF DESCRIPTION OF DRAWINGS

FIG. 1 is a perspective view of a sequencer system according to a first embodiment.

FIG. 2 is a schematic diagram of a configuration of the sequencer system according to the first embodiment.

FIG. 3 is a block diagram of the configuration of the sequencer system according to the first embodiment.

FIG. 4 is a timing chart for explaining inter-unit synchronous control in the sequencer system according to the first embodiment.

FIG. 5 is a perspective view of a sequencer system according to a second embodiment.

FIG. 6 is a schematic diagram of a configuration of the sequencer system according to the second embodiment.

FIG. 7 is a block diagram of the configuration of the sequencer system according to the second embodiment.

FIG. 8 is a timing chart for explaining an operation of a counter control unit.

FIG. 9 is a timing chart for explaining inter-unit synchronous control in the sequencer system according to the second embodiment.

FIG. 10 is a perspective view of a sequencer system according to a third embodiment.

FIG. 11 is a schematic diagram of a configuration of the sequencer system according to the third embodiment.

FIG. 12 is a block diagram of the configuration of the sequencer system according to the third embodiment.

FIG. 13 is a timing chart for explaining inter-unit synchronous control in the sequencer system according to the third embodiment.

FIG. 14 depicts a sequencer system according to a sixth embodiment and remote units connected thereto via a network cable.

FIG. 15 depicts a state where sequencer systems according to a seventh embodiment are connected to each other via a network unit.

FIG. 16 is an explanatory diagram of a background technique.

FIG. 17 is an explanatory diagram of a background technique.

### DESCRIPTION OF EMBODIMENTS

Exemplary embodiments of a sequencer system and a control method therefor according to the present invention will be explained below in detail with reference to the accompanying drawings. The present invention is not limited to the embodiments.

### First Embodiment

A sequencer system according to a first embodiment has a configuration having, for example, two CPU units, two input units, and two output units. In the sequencer system, processes from an input latch process in the input unit, through a program process (data computation and processing) in the CPU unit, to an output update process in the output unit are performed in a fixed cycle.

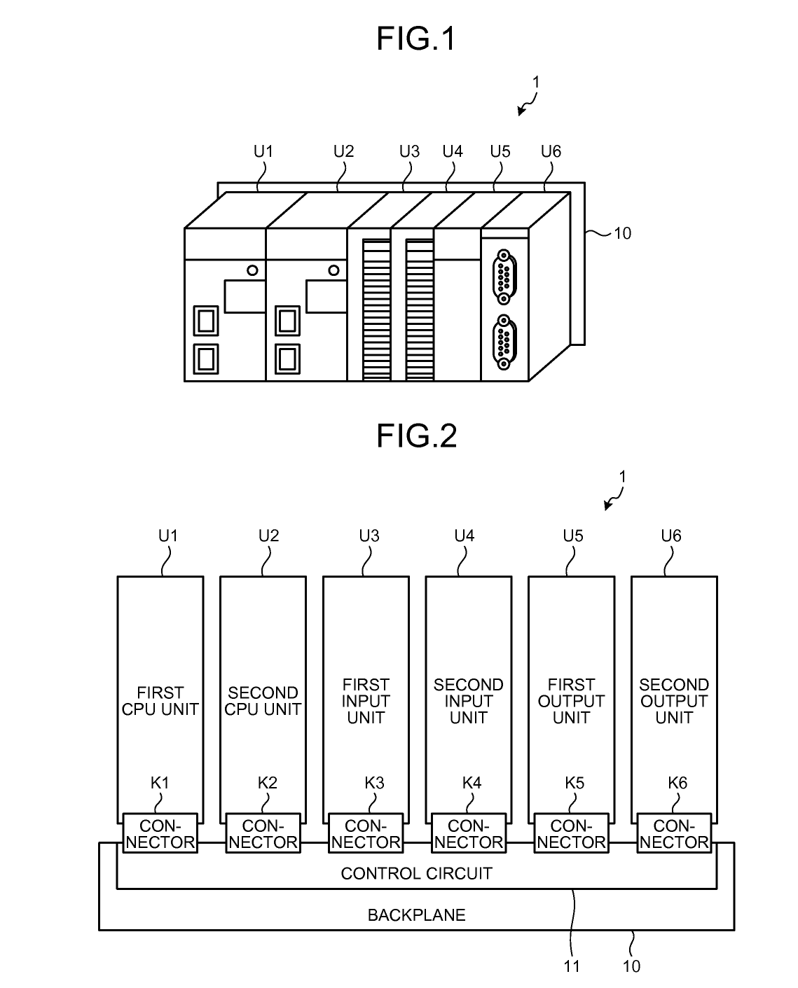

FIG. 1 is a perspective view of a sequencer system according to the first embodiment. A sequencer system 1 according to the first embodiment includes a backplane 10 and one or plural building block-type units.

The sequencer system 1 is configured so that one or plural units can be attached or detached.

The sequencer system 1 has a configuration in which for example, n (n is a natural number) units can be attached, and m (m is a natural number and m≦n) units are attached at any positions according to need. As an example of the sequencer system 1, a configuration having six units U1 to U6 (the first CPU unit U1, the second CPU unit U2, the first input unit U3, the second input unit U4, the first output unit U5, and the second output unit U6) is shown here.

The backplane 10 has, for example, a plate shape. On the surface of the backplane 10, a plurality of slots (not shown) for attaching the units is provided. On the backplane 10, the unit is attached to the slot. Attachment positions of the respective units in the backplane 10 can be appropriately selected. Even if there is a slot to which a unit is not attached in the backplane 10, the sequencer system 1 can operate.

The sequencer system 1 can use a combination of a plurality of backplanes 10 so that respective backplanes 10 can be connected to each other directly or via a cable (not shown). Accordingly, freedom in installation of the sequencer system 1 is improved, and the configuration of the sequencer system 1 can be selected in accordance with the shape of a board selected by a user. Furthermore, the shape of the board can be selected in accordance with the configuration of the user system and device and an installation place. The board here is for attaching to or housing a control device, an electric device, and the like, and indicates a cabinet made of a material such as a steel plate or that having a similar function.

The respective units U1 to U6 have a shape of, for example, cuboid. The respective units U1 to U6 are provided with a control panel and an input terminal and an output terminal of a signal on a front surface. Further, the respective units U1 to U6 are provided with a connection pin for connection with the backplane 10 and the like on a back surface.

The sequencer system 1 is mounted with the respective units U1 to U6 on the backplane 10, and the surface of the backplane 10 and the back surfaces of the respective units U1 to U6 are connected to each other via a connector.

FIG. 2 is a schematic diagram of a configuration of the sequencer system according to the first embodiment.

The backplane 10 is configured to include, for example, a printed circuit board, and includes a predetermined circuit (a control circuit 11 or the like) on the printed circuit board. The control circuit 11 is configured to include a circuit for transferring a fixed-cycle clock signal that enables inter-unit synchronous control among the units U1 to U6 and a circuit for performing data transmission and reception among the units U1 to U6 (a communication-relay control unit 12 described later or the like). Further, the backplane 10 includes connectors K1 to K6 provided on the surface for connecting the respective units U1 to U6.

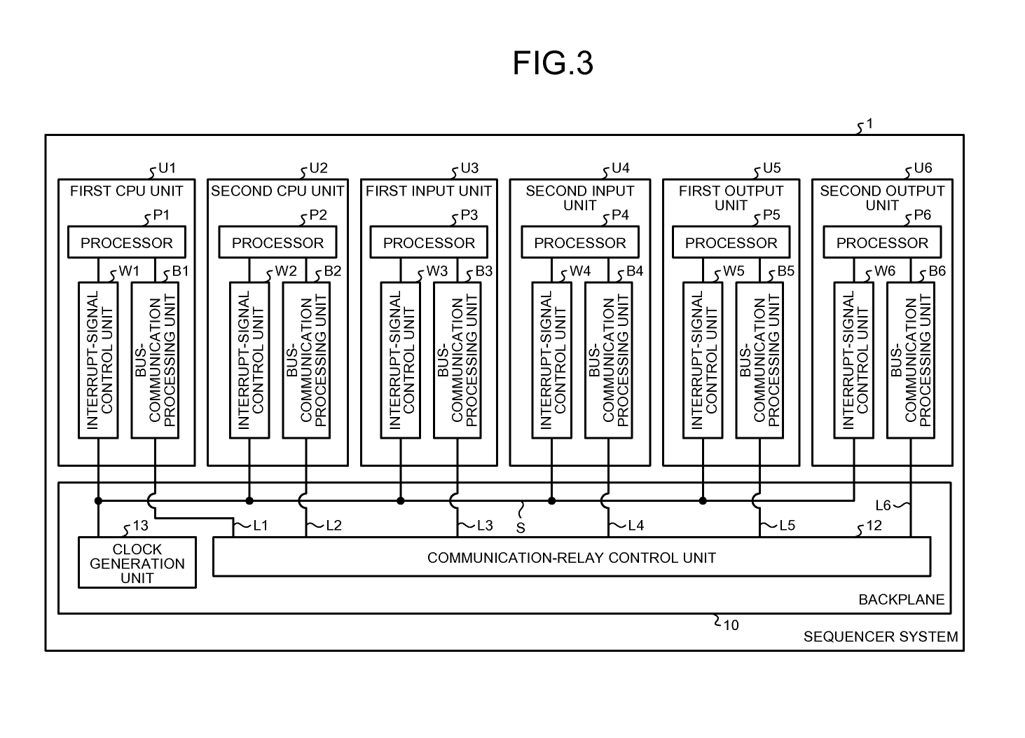

FIG. 3 is a block diagram of the configuration of the sequencer system according to the first embodiment. The units U1 to U6 each have various functions such as the CPU unit, the input unit, and the output unit. The units U1 to U6 also have a function of receiving the fixed-cycle clock signal for enabling the inter-unit synchronous control from a clock generation unit 13.

Furthermore, the units U1 to U6 each have a function of transmitting and receiving required data among the respective units. The units U1 to U6 are respectively connected to bus communication lines L1 to L6 and an electric signal line S. The bus communication lines L1 to L6 are for transmitting and receiving data among the units. The electric signal line S is provided separately from the bus communication lines L1 to L6. The electric signal line S transfers the fixed-cycle clock signal from the clock generation unit 13 to the units U1 to U6 via the backplane 10.

The units U1 to U6 respectively have processors P1 to P6, bus-communication processing units B1 to B6, and interrupt-signal control units W1 to W6. The processors P1 to P6 are respectively provided in accordance with the function of the units U1 to U6, and each have a memory (not shown) inside and outside the processors P1 to P6, according to the function. The bus-communication processing units B1 to B6 each have a function of transmitting and receiving required data among the respective units. The interrupt-signal control units W1 to W6 each have a function of receiving the fixed-cycle clock signal.

A process procedure of the fixed-cycle clock signal for enabling the inter-unit synchronous control according to the first embodiment is explained below in detail. The units U1 to U6 have the same configuration, and perform the same processing. Therefore, the first CPU unit U1 (hereinafter, simply “unit U1”) is explained as an example.

The unit U1 includes an interrupt-signal control unit W1 as a function of receiving the fixed-cycle clock signal and generating and transferring an interrupt signal to the processor P1. The electric signal line S for transferring the fixed-cycle clock signal and the clock generation unit 13 are provided on the backplane 10.

The fixed-cycle clock signal for enabling the inter-unit synchronous control is generated by the clock generation unit 13, and transferred to the unit U1 and the like through the electric signal line S. The clock generation unit 13 outputs a fixed-cycle clock signal having an arbitrary cycle to the electric signal line S based on a set value or a command written by the processor P1 of the unit U1 or a programming environment S/W (a personal computer or the like).

Start and stop of the fixed-cycle clock signal can be controlled by a command from the processor P1 of the unit U1 or the programming environment S/W (a personal computer or the like). The way to control the start and stop of the fixed-cycle clock signal includes such a method in which an output is automatically started after write of the set value is completed, and automatically stopped due to detection of an abnormality.

The interrupt-signal control unit W1 directly receives the fixed-cycle clock signal transferred through the electric signal line S, and generates and transfers an interrupt signal to the processor P1 at a rising edge, at a falling edge, or at both the edges of the fixed-cycle clock signal. When the unit U1 does not execute the inter-unit synchronous control, the interrupt-signal control unit W1 stops the operation thereof.

The processor P1 is a data computation and processing unit that controls the unit U1, and performs transmission and reception of predetermined data to and from the bus-communication processing unit B1 and an external device (not shown) according to need. The processor P1 reads a program or a set value stored in a predetermined memory (not shown), receives data of the memory or a register (not shown) inside and outside the processor P1, performs the computation and processing, and performs input and output or transmission and reception to and from the external device or another unit, based on an instruction of the read program or set value.

When executing the inter-unit synchronous control according to the first embodiment, the processor P1 performs an operation based on an instruction of the predetermined program or set value, upon reception of the interrupt signal transferred from the interrupt-signal control unit W1. The processor P1 performs the operation in priority to other program processes or from an operation execution waiting state, in response to the reception of the interrupt signal.

The units U1 to U6 each use the same fixed-cycle clock signal and perform the same process procedures as those of the unit U1, thereby operating in synchronization with each other.

A configuration for data transmission and reception among the units U1 to U6 according to the first embodiment is explained next.

The units U1 to U6 respectively have the bus-communication processing unit B1 to B6 for performing data transmission and reception, and are connected to the communication-relay control unit 12 on a one-to-one basis via the bus communication lines L1 to L6. The units U1 to U6 can perform an asynchronous data transmission and reception process with any correspondent by using the bus-communication processing units B1 and B6. The communication-relay control unit 12 controls the data transmission and reception among the units U1 to U6 by relaying. When the units U1 to U6 perform communication asynchronously, the communication-relay control unit 12 has a mediation function when there are transmission or reception requests from a plurality of units to one unit. The communication-relay control unit 12 can be provided in any of the units U1 to U6, other than the backplane 10. The sequencer system 1 can perform data transmission and reception similarly even when the communication-relay control unit 12 is provided at any position.

To execute the inter-unit synchronous control according to the first embodiment, a program process and the like including transmission and reception of data required for the inter-unit synchronous control need to be implemented in each unit among the units that execute the inter-unit synchronous control, within a specific cycle of the fixed-cycle clock signal. Therefore, the processors P1 to P6 of the units U1 to U6 each have a function of monitoring whether respective operation processes, which are activated upon reception of the interrupt signal transferred from the interrupt-signal control units W1 to W6, have been completed within the specific cycle of the fixed-cycle clock signal. Furthermore, the processors P1 to P6 have a function of stopping the control when there is an abnormality in the monitoring result of completion of the operation processes, and a function of informing the abnormality to the user. The user can select whether to stop the control with respect to the abnormality.

Conventionally, the sequencer system prepares a unit that manages the entire system, referred to as “master unit” so that the entire system can be controlled. In the sequencer system 1 according to the first embodiment, the first CPU unit U1 has a function of the master unit. According to the first embodiment, the first CPU unit U1 has a function of monitoring an abnormality in each of the units U1 to U6, including an abnormality in data transmission and reception involved with the inter-unit synchronous control in the units U1 to U6. The first CPU unit U1 has a function of performing an appropriate process when the process is required in the entire sequencer system 1, such as when an abnormality has been detected by monitoring, for example, a function of stopping the operation of all the units U1 to U6.

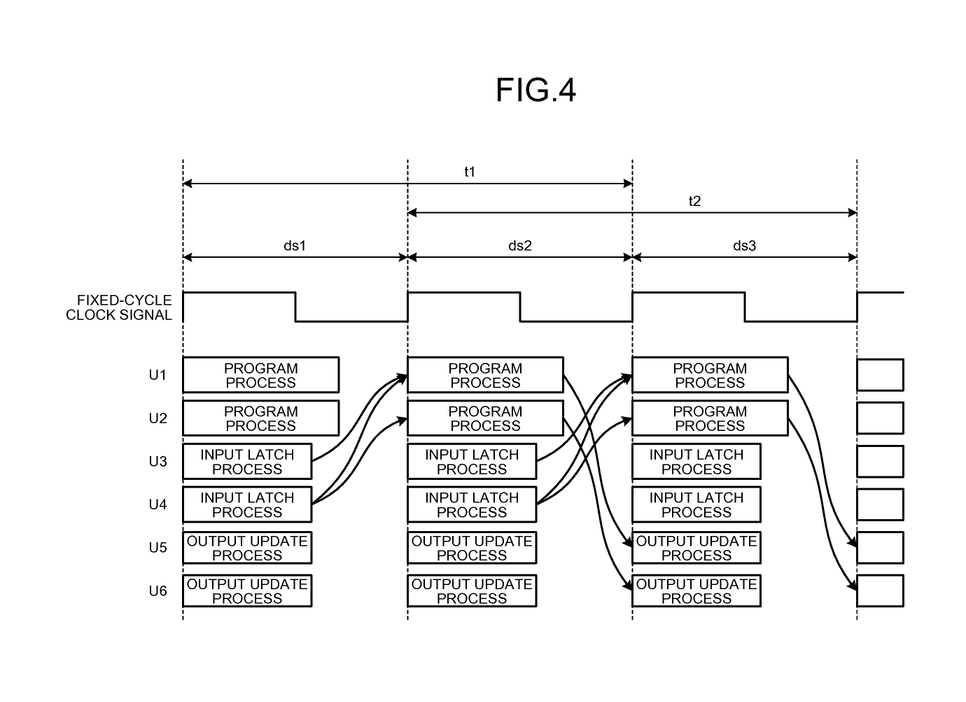

FIG. 4 is a timing chart for explaining the inter-unit synchronous control in the sequencer system according to the first embodiment. A process procedure of the inter-unit synchronous control according to the first embodiment is explained with reference to FIG. 4.

Data having subjected to the input latch process in the first input unit U3 and the second input unit U4 at a timing of the rising edge of the fixed-cycle clock signal at the beginning of a certain synchronization cycle ds1 (=ds) is transferred to the first CPU unit U1 and the second CPU unit U2 within a period of the same synchronization cycle ds1.

At a timing of the rising edge of the fixed-cycle clock signal at the beginning of the next synchronization cycle ds2 (=ds), the first CPU unit U1 and the second CPU unit U2 perform a program process by using data transferred from the first input unit U3 and the second input unit U4 in the previous synchronization cycle ds1 and internal data held at the current timing. The first CPU unit U1 and the second CPU unit U2 transfer the execution result of the program process to the first input unit U3 and the second input unit U4 in the period of the same synchronization cycle ds2.

At a timing of the rising edge of the fixed-cycle clock signal at the beginning of the next synchronization cycle ds3 (=ds), the first output unit U5 and the second output unit U6 perform the output update process by using the data transferred from the first CPU unit U1 and the second CPU unit U2 in the previous synchronization cycle ds2.

A time t1 from the input latch process to the output update process corresponds to a synchronization cycle ds×2. The respective units U1 to U6 continuously execute respective processes in each synchronization cycle ds. A time t2 from the next input latch process to the output update process also corresponds to the synchronization cycle ds×2, as the time t1. Transfer of data can be actively performed by the CPU units U1 and U2, or can be actively performed by the input units U3 and U4 and the output units U5 and U6.

As described above, according to the first embodiment, as the inter-unit synchronous control using a plurality of units U1 to U6, the processes from the input latch process in the input units U3 and U4, through the program process (data computation and processing) in the CPU units U1 and U2, to the output update process in the output units U5 and U6 can be performed in a fixed cycle (the synchronization cycle ds×2). Furthermore, the continuous inter-unit synchronous control in each synchronization cycle ds can be executed.

The sequencer system 1 can realize the inter-unit synchronous control in any cycle by adding a simple and inexpensive configuration including the electric signal line S and the interrupt-signal control units W1 to W6 to the existing configuration. Further, as means for contributing to performance improvement of the user system using the sequencer and the entire device, the inter-unit synchronous control from the input change timing of various I/O through the control process such as data computation and processing to the output change timing can be realized. Accordingly, when the advanced control theory such as predictive control is used for the user program processed by the CPU units U1 and U2, expected effects can be acquired sufficiently.

The clock generation unit 13 can be provided either in the first CPU unit U1 as the master unit or the units U2 to U6 except for the master unit, other than in the backplane 10. The sequencer system 1 can execute the inter-unit synchronous control similarly when the clock generation unit 13 is provided at either position.

The units U1 to U6 each can select whether to execute the inter-unit synchronous control by the fixed-cycle clock signal. Accordingly, the sequencer system 1 can execute the inter-unit synchronous control by selecting a desired unit.

### Second Embodiment

A sequencer system according to a second embodiment is added with a counter control unit in each unit of the configuration in the first embodiment and executes inter-unit synchronous control by using the counter control units. In the first embodiment, the processes from the input latch process to the output update process are synchronously controlled, whereas in the second embodiment, synchronous control from an input change timing to an output change timing can be realized. Elements identical to those of the first embodiment are denoted by like reference signs and redundant explanations thereof will be appropriately omitted.

The sequencer system according to the second embodiment has a configuration in which, for example, one CPU unit, one input unit, and one output unit are provided, and performs processing from an input change timing of an external input terminal of an input unit, through a program process (data computation and processing) in the CPU unit, to an output change timing of an external output terminal of an output unit in a fixed cycle.

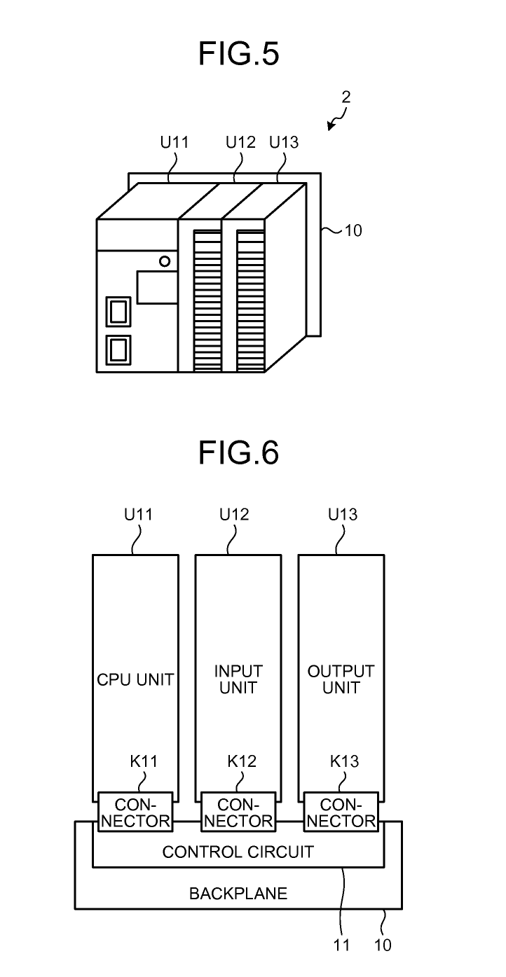

FIG. 5 is a perspective view of a sequencer system according to the second embodiment. As an example of a sequencer system 2 according to the second embodiment, a configuration having three units U11 to U13 (a CPU unit U11, an input unit U12, and an output unit U13) is shown.

FIG. 6 is a schematic diagram of a configuration of the sequencer system according to the second embodiment. The backplane 10 includes connectors K11 to K13 provided on the surface for connecting the respective units U11 to U13.

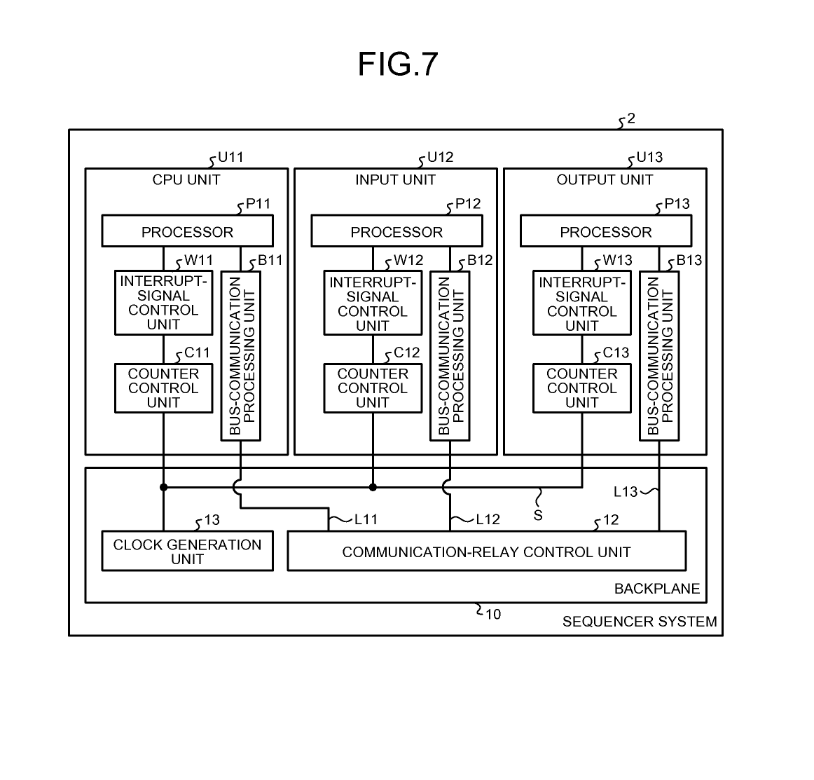

FIG. 7 is a block diagram of the configuration of the sequencer system according to the second embodiment. The units U11 to U13 are respectively connected to the bus communication lines L11 to L13 and the electric signal line S. The bus communication lines L11 to L13 are for transmitting and receiving data among the units. The electric signal line S is provided separately from the bus communication lines L11 to L13.

The units U11 to U13 respectively have processors P11 to P13, bus-communication processing units B11 to B13, interrupt-signal control units W11 to W13, and counter control units C11 to C13. The processors P11 to P13 are respectively provided in accordance with the functions of the units U11 to U13, and have a memory (not shown) inside and outside the processors P11 to P13, according to the functions. The bus-communication processing units B11 to B13 each have a function of transmitting and receiving necessary data between the units.

The counter control units C11 to C13 respectively have a function of receiving a fixed-cycle clock signal.

The interrupt-signal control units W11 to W13 operate in cooperation with the counter control units C11 to C13.

A process procedure of the fixed-cycle clock signal for enabling inter-unit synchronous control according to the second embodiment is explained here in detail. The units U11 to U13 have the same configuration, and perform the same processing. Therefore, the CPU unit U11 (hereinafter, simply “unit U11”) is explained as an example.

The unit U11 includes the counter control unit C11 as a function of receiving the fixed-cycle clock signal and controlling a synchronous counter. The unit U11 includes an interrupt-signal control unit W11 as a function of generating and transferring an interrupt signal to the processor P11 in cooperation with the counter control unit C11.

The fixed-cycle clock signal for enabling the inter-unit synchronous control is generated by the clock generation unit 13, and transferred to the unit U11 and the like through the electric signal line S. The clock generation unit 13 has a function capable of generating a fixed-cycle clock signal having an arbitrary cycle as in the first embodiment. The clock generation unit 13 outputs the fixed-cycle clock signal having the arbitrary cycle to the electric signal line S. The clock generation unit 13 can control start and stop of the fixed-cycle clock signal as in the first embodiment.

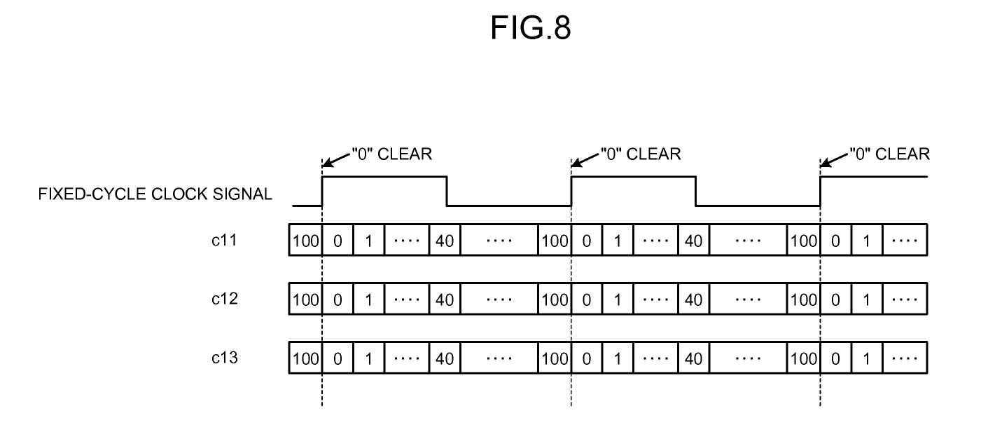

FIG. 8 is a timing chart for explaining an operation of the counter control unit. The counter control units C11 to C13 each receive a fixed-cycle clock signal transferred through the electric signal line S, and respectively execute zero clear (hereinafter, “0” clear) of the synchronous counters c11 to c13 in the counter control units C11 to C13, at a rising edge, at a falling edge, or at both the edges of the fixed-cycle clock signal.

It is assumed that an operating frequency of each of the counter control units C11 to C13 of the respective units U11 to U13 is the same. The counter control units C11 to C13 perform “0” clear of the synchronous counters c11 to c13 simultaneously, and cause the synchronous counters c11 to c13 to count up in the same cycle.

The interrupt-signal control unit W11 operates in cooperation with the counter control unit C11. The interrupt-signal control unit W11 generates an interrupt signal when an arbitrary value informed from the processor P11 or the like matches with a value of the synchronous counter in the counter control unit C11, and transfers the interrupt signal to the processor P11. Furthermore, the interrupt-signal control unit W11 latches the value of the synchronous counter in the counter control unit C11 by generating an interrupt signal based on a command from the processor P11 or the like and transferring the interrupt signal to the counter control unit C11, and transfers the value to the processor P11 or writes the value in a predetermined memory.

The processor P11 is a data computation and processing unit as in the first embodiment, and controls the unit U11 and performs transmission and reception of predetermined data to and from the bus-communication processing unit B11 and an external device (not shown) according to need.

The processor P11 causes the unit U11 to perform either of two operations described below, as an operation for executing the inter-unit synchronous control according to the second embodiment.

A first operation is performed based on a preset program or a preset instruction, when the interrupt signal transferred from the interrupt-signal control unit W11 is received by the processor P11. The processor P11 performs the operation in priority to other program processes or from the operation execution waiting state, in response to the reception of the interrupt signal. The processor P11 transfers an arbitrary value to the interrupt-signal control unit W11 and receives the interrupt signal from the interrupt-signal control unit W11 to perform the operation at an arbitrary value of the synchronous counter in the counter control unit C11.

A second operation is to transfer a command to the interrupt-signal control unit W11 depending on reception of data from an external device (not shown), the change timing of the external input data, or the result of data computation and processing, thereby to latch and read the value of the synchronous counter in the counter control unit C11.

The configuration for data transmission and reception and monitoring of an abnormality in the units U11 to U13 are identical to those of the first embodiment.

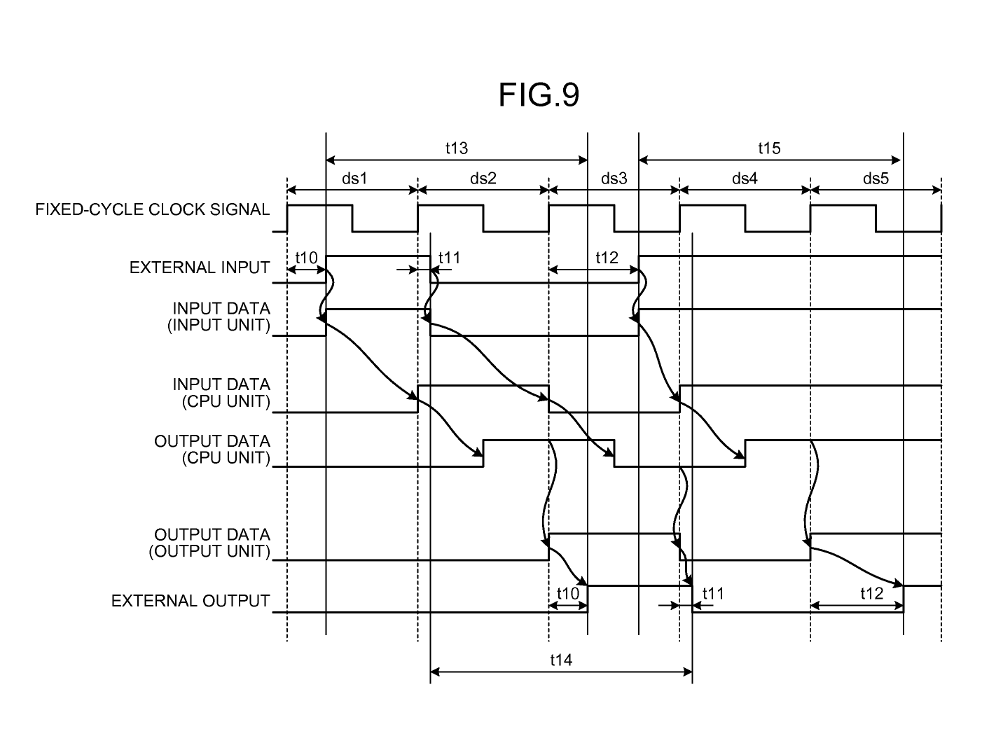

FIG. 9 is a timing chart for explaining the inter-unit synchronous control in the sequencer system according to the second embodiment. The counter control units C11 to C13 in the units U11 to U13 perform “0” clear of the synchronous counter at the timing of the rising edge of the fixed-cycle clock signal, and count up at the same operating frequency.

When a change occurs in the external input within a certain synchronization cycle ds1 (=ds) and the input unit U12 detects the change in the external input, the input unit U12 latches the input data after the change and input change timing data which indicates a value of the synchronous counter c12 (t10) at that timing.

The CPU unit U11 refreshes the input data in the same synchronous cycle ds1. The CPU unit U11 receives the input data and the input change timing data latched by the input unit U12.

At a timing of the rising edge of the fixed-cycle clock signal at the beginning of the next synchronization cycle ds2 (=ds), the processor P11 of the CPU unit U11 performs a program process by using data received through the input/output refresh process in the previous synchronization cycle ds1 and internal data held at the current timing. The processor P11 transfers the execution result of the program process and the input change timing data of the input data used for the program process to the output unit U13 in the input/output refresh process in the synchronization cycle ds2. It is assumed here that the processor P11 receives an interrupt signal from the interrupt-signal control unit W11 when the value of the synchronous counter is “0”.

Furthermore, in the next synchronization cycle ds3 (=ds), the output unit U13 performs an update change process of an external output terminal at a timing when the value of the synchronous counter c13 becomes t10. The output unit U13 performs in the previous synchronization cycle ds2 the update change process based on the execution result of the program process transferred from the CPU unit U11 in the input/output refresh process. A time t13 from a change in the external input to a change in the external output corresponds to the synchronization cycle ds×2. The input/output refresh process is executed up to the end of each synchronization cycle ds.

In the synchronization cycle ds2, it is assumed that there is a change in the next external input at a timing when the value of the synchronous counter c12 is t11. Corresponding thereto, the output unit U13 performs the update change process of the external output terminal at a timing when the value of the synchronous counter c13 becomes t11 in the synchronization cycle ds4. A time t14 from a change in the external input to a change in the external output corresponds to the synchronization cycle ds×2.

In the synchronization cycle ds3, it is assumed that there is a change in the next external input at a timing when the value of the synchronous counter c12 is t12. Corresponding thereto, the output unit U13 performs the update change process of the external output terminal at a timing when the value of the synchronous counter c13 becomes t12 in the synchronization cycle ds5. A time t15 from a change in the external input to a change in the external output corresponds to the synchronization cycle ds×2.

Respective units U11 to U13 continuously execute respective processes in each synchronization cycle ds. Transfer of data can be actively performed by the CPU unit U11, or can be actively performed by the input unit U12 and the output unit U13.

As described above, according to the second embodiment, as the inter-unit synchronous control using a plurality of units U11 to U13, the processing from the change in the external input in the input unit U12, through the program process (data computation and processing) in the CPU unit U11, to the change in the external output in the output unit U3 can be performed in a fixed cycle (the synchronization cycle ds×2). Furthermore, the continuous inter-unit synchronous control in each synchronization cycle ds1 can be executed.

The sequencer system 2 can perform an operation to maintain a constant time from the external input change to the external output change by utilizing the value of the synchronous counter, which is “0”—cleared by the fixed-cycle clock signal for the control process in the respective units U11 to U13. Further, the control to ensure the accuracy can be executed by maintaining the constant time from the external input change to the external output change, as means for contributing to performance improvement of the user system using the sequencer and the entire device, thereby enabling to achieve high performance and high functionality.

Furthermore, as the timing for the output unit U13 to perform the update change process of the external output terminal, program-processed values t10′, t11′, and t12′ can be applied to the input change timing data t10, t11, and t12. Accordingly, the sequencer system 2 can execute control, for example, to change the timing of the output update process from the external input state by the user, thereby enabling to achieve high performance and high functionality of the user system and device.

In the second embodiment, such a case where there is one input change in one synchronization cycle ds is shown as an example. However, an identical operation can be performed even when there are a plurality of input changes in one synchronization cycle ds. By performing the latch process in the input unit U12, the program process in the CPU unit U11, and the update change process in the output unit U13 for each input change, an identical operation can be performed when there is one or plural input changes in one synchronization cycle ds.

### Third Embodiment

A sequencer system according to a third embodiment applies the inter-unit synchronous control to a combination of units other than the CPU unit of the configuration according to the second embodiment. The configuration of the third embodiment is such that a selector unit provided in the electric signal line S is added to the configuration of the second embodiment. Elements identical to those of the second embodiment are denoted by like reference signs and redundant explanations thereof will be appropriately omitted.

The sequencer system according to the third embodiment has a configuration, for example, having a CPU unit, an input unit, an output unit, a highly functional input unit, and a highly functional output unit one each.

From an input latch process in the highly functional input unit, through data computation and processing in the highly functional output unit, to an output update process in the highly functional output unit are performed in a fixed cycle. The units other than the highly functional input unit and the highly functional output unit execute the conventional sequence control.

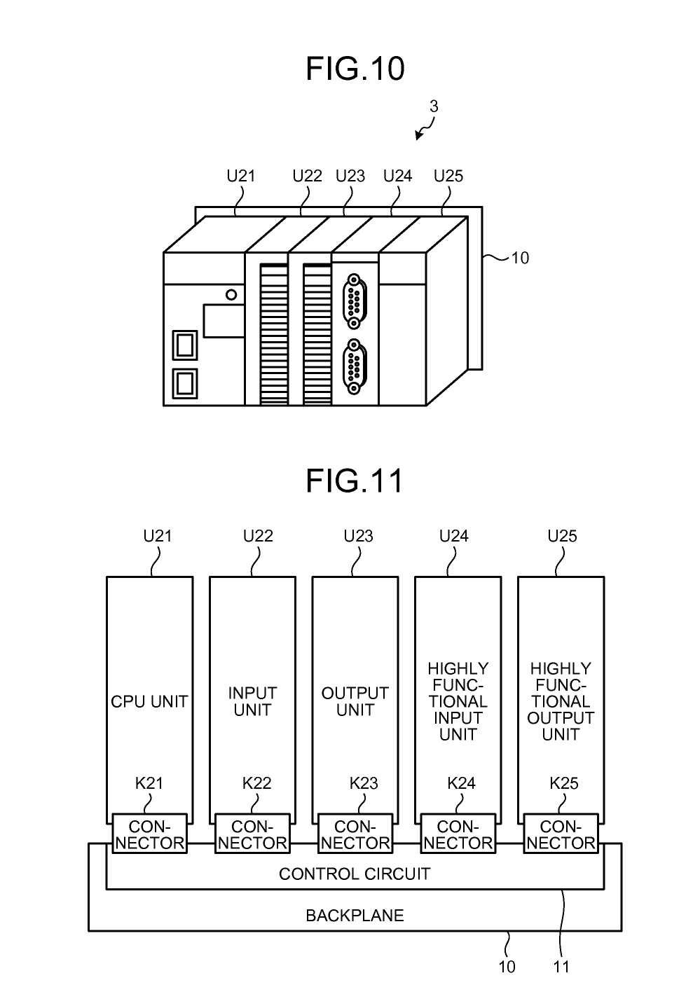

FIG. 10 is a perspective view of a sequencer system according to the third embodiment. As an example of a sequencer system 3 according to the third embodiment, a configuration having five units U21 to U25 (a CPU unit U21, an input unit U22, an output unit U23, a highly functional input unit U24, and a highly functional output unit U25) is shown.

FIG. 11 is a schematic diagram of the configuration of a sequencer system according to the third embodiment. The backplane 10 includes connectors K21 to K25 provided on the surface for connecting the respective units U21 to U25.

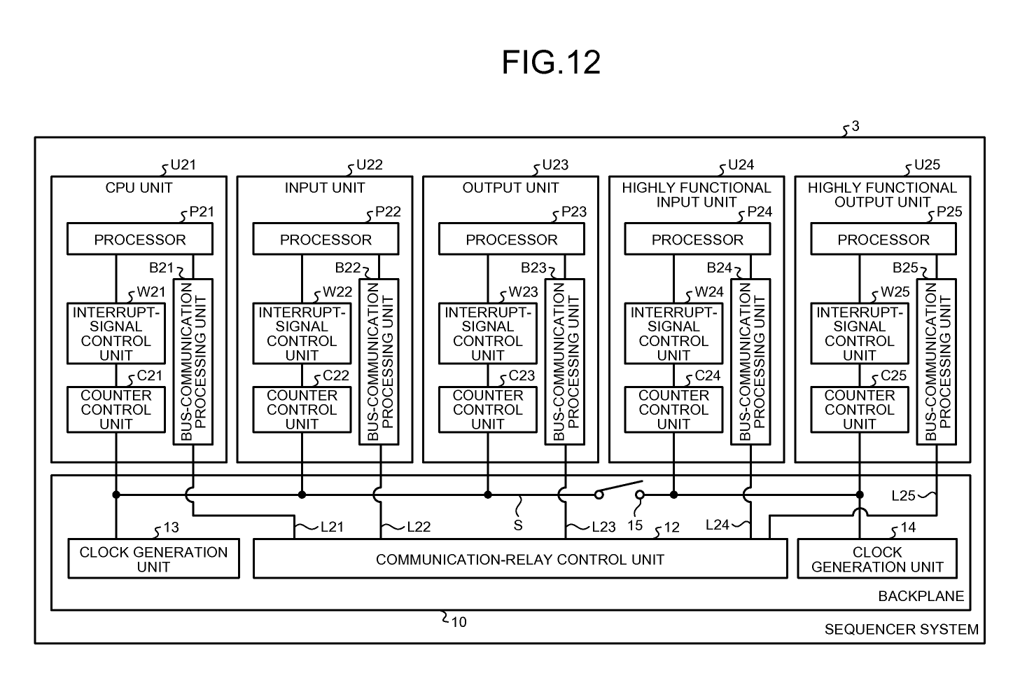

FIG. 12 is a block diagram of the configuration of the sequencer system according to the third embodiment. The third embodiment is different from the second embodiment such that two clock generation units 13 and 14, and a selector unit 15 are provided.

The units U21 to U25 are respectively connected to bus communication lines L21 to L25 and the electric signal line S. The bus communication lines L21 to L25 are for transmitting and receiving data among the units. The electric signal line S is provided separately from the bus communication lines L21 to L25.

The units U21 to U25 respectively have processors P21 to P25, bus-communication processing units B21 to B25, interrupt-signal control units W21 to W25, and counter control units C21 to C25. The processors P21 to P25 are provided in accordance with the functions of the units U21 to U25, and have a memory (not shown) inside or outside the processors P21 to P25, according to the function. The bus-communication processing units B21 to B25 each have a function of transmitting and receiving necessary data between the units.

The counter control units C21 to C25 each have a function of receiving a fixed-cycle clock signal. The interrupt-signal control units W21 to W25 operate in cooperation with the counter control units C21 to C25.

The selector unit 15 is arranged on the electric signal line S. On the electric signal line S, the CPU unit U21, the input unit U22, the output unit U23, the highly functional input unit U24, and the highly functional output unit U25 are arranged in parallel in this order, and the selector unit 15 is arranged between the output unit U23 and the highly functional input unit U24. The selector unit 15 can selectively switch between connection and disconnection of the electric signal line S. In the third embodiment, the selector unit 15 is in a state of disconnecting the electric signal line S. In FIG. 12, the selector unit 15 is arranged on the backplane 10; however, the installation position can be a position other than on the backplane 10.

The electric signal line S is divided into two by the selector unit 15. By disconnecting the electric signal line S by the selector unit 15, the units U21 to U25 of the sequencer system 3 are grouped into the units U21 to U23 and the units U24 to U25, which are connected to each other by the electric signal line S. According to the third embodiment, a fixed-cycle clock signal generated by one clock generation unit 14 is transferred only to the units U24 to U25 by the electric signal line S, and inter-unit synchronous control is executed in the units U24 to U25.

The sequencer system 3 can create a plurality of groups in one sequencer system 3 by switching the selector unit 15 to the state of disconnecting the electric signal line S. The selector unit 15 operates based on a set value or a command written by the processor P21 of the CPU unit U21 or the programming environment S/W (a personal computer or the like).

Generation and transfer of the fixed-cycle clock signal for the inter-unit synchronous control in the units U24 to U25, and the respective operations of the counter control units C24 and C25, the interrupt-signal control units W21 to W25, and the processors P24 and P25 are identical to those of the second embodiment.

The configuration for data transmission and reception and monitoring of an abnormality in the units U21 to U25 are identical to those of the second embodiment. However, in the third embodiment, with respect to the data required for the inter-unit synchronous control between the unit U24 and the unit U25, data transmission and reception are performed steadily only between the unit U24 and the unit U25.

The sequencer system 3 can execute highly accurate fixed-cycle control, a high-speed response process, and the like for the unit U24 and the unit U25 by stable inter-unit synchronous control without being affected by the control of the CPU unit U21 that manages the entire sequencer system 3 and the communication. Furthermore, regarding the CPU unit U21, there is an effect of reducing the control and communication loads. These contribute to the performance improvement of the entire sequencer system 3.

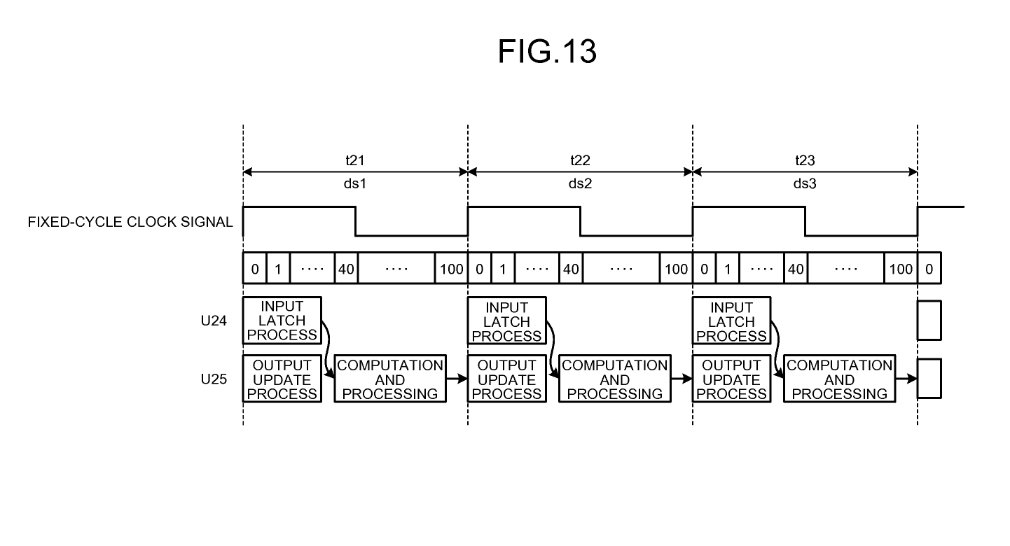

FIG. 13 is a timing chart for explaining the inter-unit synchronous control in the sequencer system according to the third embodiment. The counter control units C24 and C25 in the units U24 and U25 respectively perform “0” clear of the synchronous counter at the timing of the rising edge of the fixed-cycle clock signal, and count up at the same operating frequency.

When the value of the synchronous counter c in a certain synchronization cycle ds1 (=ds) is “0”, that is, at the timing of the rising edge of the fixed-cycle clock signal, the highly functional input unit U24 performs a latch process of an external input. The highly functional input unit U24 transmits input data to the highly functional output unit U25 in the same synchronization cycle ds1.

When the value of the synchronous counter c in the same synchronization cycle ds1 is “40”, the highly functional output unit U25 performs data computation and processing based on the data transferred from the highly functional input unit U24 in the same synchronization cycle ds1. When the value of the synchronous counter c in the next synchronization cycle ds2 is “0”, that is, at the timing of the rising edge of the fixed-cycle clock signal, the highly functional output unit U25 performs an update process of an external output.

The value “40” of the synchronous counter c, which becomes a starting point of the operation corresponding to the input data in the highly functional output unit U25, is a preset value for the inter-unit synchronous control. It is assumed that the value sufficiently satisfies the time required for completion of the input latch process in the highly functional input unit U24, transfer of the input data among the units, and the output update process in the highly functional output unit U25.

The highly functional input unit U24 and the highly functional output unit U25 continuously execute the respective processes in each synchronization cycle ds. Times t21, t22, and t23 from the input latch process to the output update process respectively correspond to the synchronization cycle ds. Transfer of data can be actively performed by the highly functional input unit U24, or can be actively performed by the highly functional output unit U25.

As described above, according to the third embodiment, synchronous control in the combination of the units other than the CPU unit U21 can be realized by a simple and inexpensive configuration. Furthermore, the conventional sequence control and the inter-unit synchronous control can exist together in one sequencer system 3.

The sequencer system 3 can apply the conventional sequence control to the units U21 to U23, by setting the electric signal line S to a connected state in the selector unit 15 and stopping the operations of the counter control units C21 to C23 and the interrupt-signal control units W21 to W23 of the units U21 to U23.

The sequencer system 3 can have such a configuration that a plurality of electric signal lines (not shown) are provided instead of providing the selector unit 15, so that the plurality of units can be grouped by selecting the electric signal line. Also in this case, the synchronous control in the combination of the units other than the CPU unit U21 can be realized by a simple and inexpensive configuration, and the conventional sequence control and the inter-unit synchronous control can exist together in one sequencer system 3.

### Fourth Embodiment

A sequencer system according to a fourth embodiment executes a multiple types of inter-unit synchronous control simultaneously in one sequencer system so that each operation can be performed in a synchronization cycle different from each other. Configurations of the fourth embodiment are identical to those of the third embodiment. Similarly to the third embodiment, the fourth embodiment refers to FIGS. 10 to 12, and redundant explanations thereof will be appropriately omitted.

The sequencer system 3 according to the fourth embodiment executes, for example, two types of inter-unit synchronous control are simultaneously performed in one sequencer system 3. The sequencer system 3 simultaneously executes the inter-unit synchronous control among three units U21 to U23 (hereinafter, “first inter-unit synchronous control”) and the inter-unit synchronous control between two units U24 to U25 (hereinafter, “second inter-unit synchronous control”) in one sequencer system 3. The first inter-unit synchronous control and the second inter-unit synchronous control have a synchronization cycle different from each other.

In the state where the electric signal line S is disconnected by the selector unit 15, the units U21 to U23 are connected to one clock generation unit 13 via the electric signal line S. A fixed-cycle clock signal generated by the clock generation unit 13 is transferred to the units U21 to U23 through the electric signal line S, and the units U21 to U23 execute the first inter-unit synchronous control. The fixed-cycle clock signal generated by the clock generation unit 14 is transferred to the units U24 and U25 through the electric signal line S, and the units U24 and U25 execute the second inter-unit synchronous control. The clock generation unit 13 and the clock generation unit 14 each generate a fixed-cycle clock signal having a frequency different from each other.

Regarding data required for the first inter-unit synchronous control, data transmission and reception are performed steadily only among the units U21 to U23. Regarding data required for the second inter-unit synchronous control, data transmission and reception are performed steadily only between the units U24 and U25.

The sequencer system 3 can execute the synchronous control in a group to which the first inter-unit synchronous control is applied and a group to which the second inter-unit synchronous control is applied, without affecting the control and communication of each group to each other. Furthermore, even if a data amount required for the synchronous control as the entire system increases by executing the first inter-unit synchronous control and the second inter-unit synchronous control in one sequencer system 3, it can be avoided that the synchronization cycle becomes long in proportion to the increase in the data amount.

As described above, according to the fourth embodiment, a multiple types of inter-unit synchronous control having a different synchronization cycle can be performed simultaneously in one sequencer system 3 with a simple configuration. The number of groups for the inter-unit synchronous control is not limited to two, and can be three or more. The sequencer system 3 can easily increase the number of groups for the inter-unit synchronous control.

The inter-unit synchronous control executed for each group simultaneously is not limited to the case where the synchronization cycle is different from each other, and the synchronization cycle can be the same. When the inter-unit synchronous control is executed for all the groups in the same synchronization cycle, the selector unit 15 can be set to the connected state, and a fixed-cycle clock signal generated by one of the clock generation units 13 and 14 can be transferred to the respective units U21 to U25. Regarding data required for the inter-unit synchronous control, data transmission and reception can be steadily performed among the units U21 to U25.

The sequencer system 3 can have such a configuration that a plurality of electric signal lines (not shown) are provided instead of providing the selector unit 15, so that the plurality of units can be grouped by each selecting the electric signal line. The clock generation unit is provided in each group into which the plurality of units are grouped by the selected electric signal line. Also in this case, the multiple types of inter-unit synchronous control with a different synchronization cycle can be performed simultaneously in one sequencer system 3.

### Fifth Embodiment

In a sequencer system according to a fifth embodiment, data transmission and reception among units in the first to fourth embodiments are not performed by respective units asynchronously, but are performed in a fixed cycle (synchronously) (for synchronization of the control process of the respective units, for example, see Patent Literature 1).

In data transmission and reception among units, for example, in the technique described in Patent Literature 1, each unit is synchronized with data transmitted from a synchronization master to transmit data to a communication-relay control unit at a predetermined timing, thereby sharing data among the units and performing an operation in a fixed cycle. By synchronizing the cycle of data transmission and reception and the cycle of a fixed-cycle clock signal for inter-unit synchronous control with each other, the inter-unit synchronous control can be executed. The cycle can be the same with each other, or in a proportional relation or in a frequency dividing relation.

According to the fifth embodiment, when the inter-unit synchronous control of a plurality of groups is to be executed in one sequencer system as in the fourth embodiment, data transmission and reception can be performed in the fixed cycle by setting the same synchronization cycle. When data transmission and reception is performed in a synchronization cycle different for each group, or when respective units are caused to operate in a synchronization cycle different for each group, a communication-relay processing unit for each group or a unit for data transmission and reception among the groups can be added. As the method of data transmission and reception among the units, both the asynchronous method according to the first to fourth embodiments and the fixed cycle method according to the fifth embodiment can be applied.

### Sixth Embodiment

A sequencer system according to a sixth embodiment transfers the fixed-cycle clock signal for the inter-unit synchronous control according to the first to fifth embodiments via a network cable. The network cable connects a network unit and a remote unit. Elements identical to those of the first embodiment are denoted by like reference signs and redundant explanations thereof will be appropriately omitted.

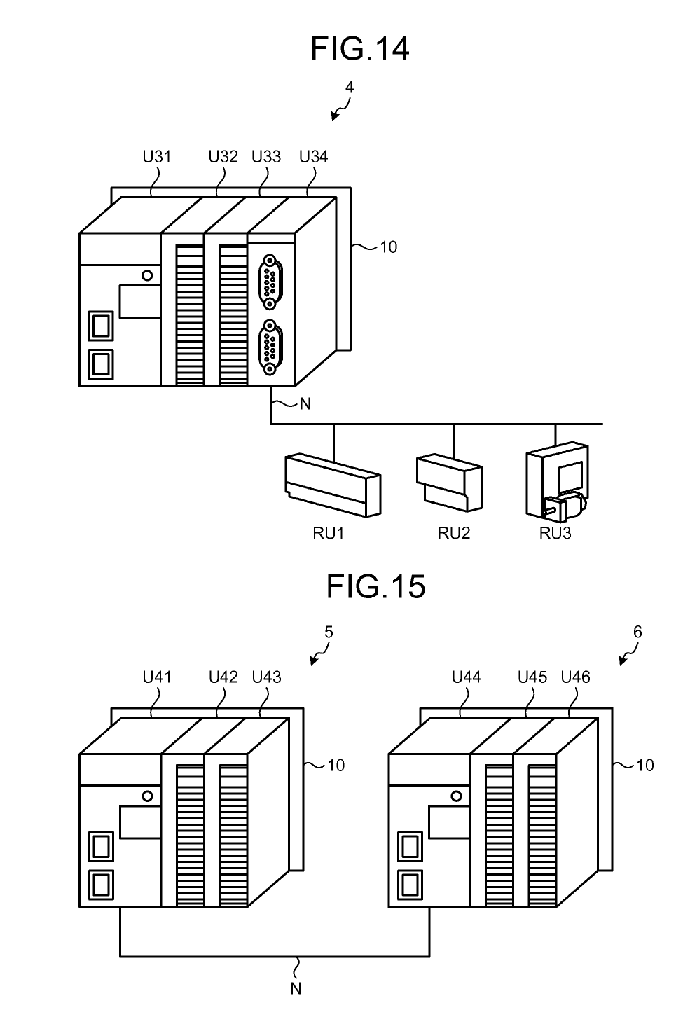

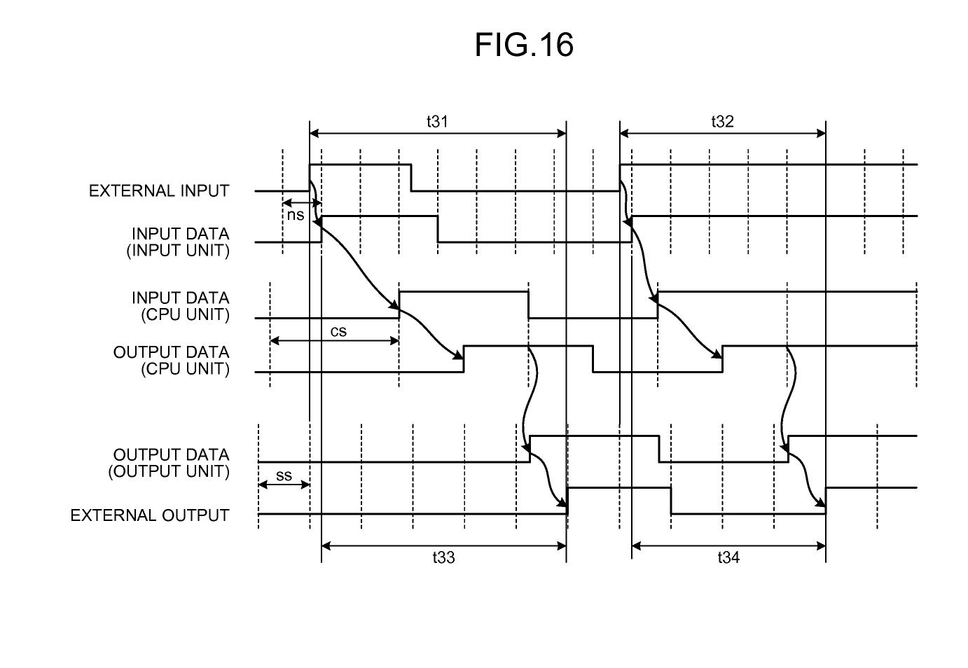

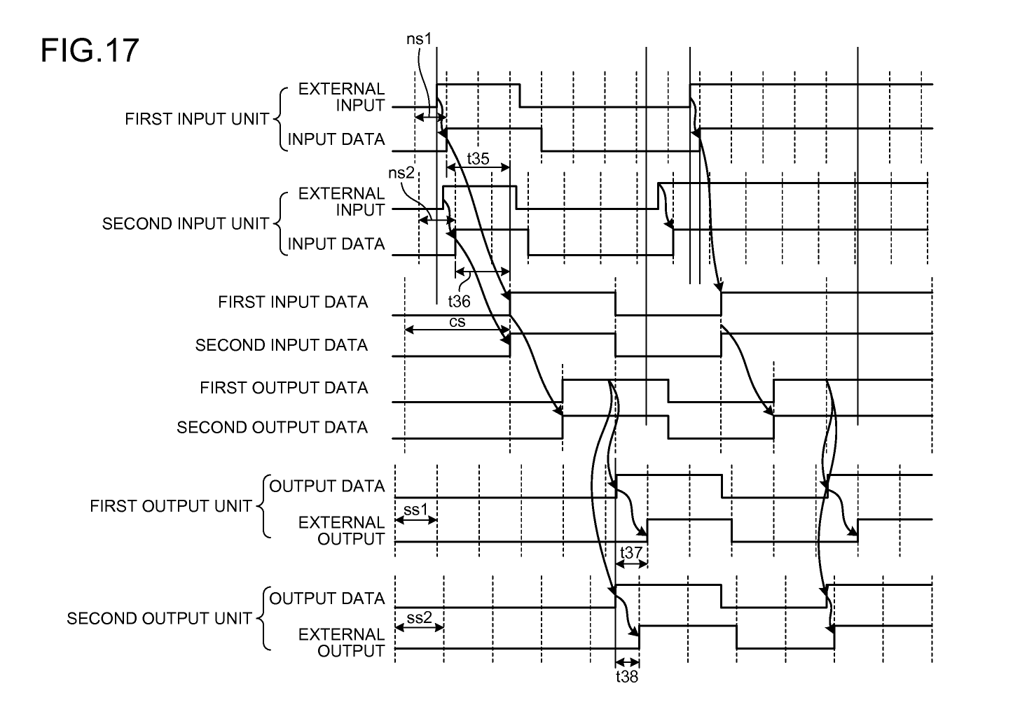

FIG. 14 depicts the sequencer system according to the sixth embodiment and remote units connected thereto via a network cable. A sequencer system 4 according to the sixth embodiment has a configuration having, for example, four units U31 to U34. The unit U34 of these units is the network unit. Remote units RU1 to RU3 are connected to the network unit U34 via a network cable N.

According to the sixth embodiment, a combination of units that execute inter-unit synchronous control can be a combination of the remote units RU1 to RU3, or a combination of the units U31 to U34 on the backplane 10 and the remote units RU1 to RU3.

The network cable N transfers the fixed-cycle clock signal for enabling the inter-unit synchronous control according to the first to fifth embodiments or transfers timing information required for enabling the inter-unit synchronous control. A connection method among the units on the network can be any of so-called line (or multi-drop) connection in which units from the network unit U34 to the remote units RU1 to RU3 are connected one after another, star connection, and ring connection, or can be a method of mixing these connection methods.

In the case of long-distance transmission on the network, a delay of the fixed-cycle clock signal or the timing information may occur and an arrival time may be different for each of the remote units RU1 to RU3. The remote units RU1 to RU3 can have a correction function with respect to the delay of the arrival time.

According to the sixth embodiment, in a user system and device in which input and output devices are dotted at places away from each other and the use of the remote unit by a wire-saving network is effective, the inter-unit synchronous control by a combination of a plurality of remote units can be realized.

The sequencer system 4 can have such a configuration in which a plurality of network units are mounted on a backplane and remote units are connected via the network cable N for each network unit. Also in this case, each network unit uses a fixed-cycle clock signal for the same inter-unit synchronous control, thereby enabling the inter-unit synchronous control among all the remote units on the network cable N. Furthermore, inter-unit synchronous control among all the remote units on the network cable N and the units on the backplane 10 can be executed.

### Seventh Embodiment

A sequencer system according to a seventh embodiment transfers the fixed-cycle clock signal for the inter-unit synchronous control according to the first to fifth embodiments to a network unit in another sequencer system via a network cable connected to a network unit.

FIG. 15 depicts a state where sequencer systems according to the seventh embodiment are connected to each other via a network unit. Sequencer systems 5 and 6 according to the seventh embodiment have a configuration, for example, having three units U41 to U43, U44 to U46, respectively. Among these units, the units U41 and U44 are the network unit. The network cable N connects the network unit U41 of the sequencer system 5 and the network unit U44 of the sequencer system 6. In the network, it is assumed that two or more units having a network function can be connected to each other.

The network units U41 and U44 respectively receive a fixed-cycle clock signal for enabling the inter-unit synchronous control according to the first to fifth embodiment. The network units U41 and U44 respectively have a function of transferring the fixed-cycle clock signal or timing information required for enabling the inter-unit synchronous control to other units via the network cable N. Furthermore, the network units U41 and U44 respectively have a function of transferring the fixed-cycle clock signal or the timing information to the units on the backplane 10 on which the unit itself is mounted.

A connection method among the network units U41 and U44 can be any of the so-called line (or multi-drop) connection in which units are connected one after another from one network unit, star connection, and ring connection, or can be a method of mixing these connection methods.

In the case of long-distance transmission on the network, a delay of the fixed-cycle clock signal or the timing information may occur and an arrival time may be different for each unit on the network. The network units U41 and U44 can have a correction function with respect to the delay of the arrival time.

According to the seventh embodiment, in a user system and device in which a plurality of sequencer systems dotted at places away from each other are connected by the network and transmission and reception of data is required among the sequencer systems, the inter-unit synchronous control by a combination of units via the network can be realized.

### INDUSTRIAL APPLICABILITY

As described above, the sequencer system and the control method therefor according to the present invention are suitable for realizing high-performance inter-unit synchronous control that enables coordination control from the input change timing of various I/O through the control process such as data computation and processing to the output change timing and fixed-cycle control by using a simple configuration as means for contributing to performance improvement of the user system that uses the sequencer and the entire device. Furthermore, the sequencer system and the control method therefor according to the present invention are suitable for realizing high-performance inter-unit synchronous control that enables to ensure synchronism of a data collection timing and to clarify temporal correlation by using a simple configuration as means for improving traceability and serviceability of the system and device that uses a sequencer.

### REFERENCE SIGNS LIST

1, 2, 3, 4, 5, 6 sequencer system
10 backplane
11 control circuit
12 communication-relay control unit
13, 14 clock generation unit
15 selector unit
B1 to B6, B11 to B13 bus-communication processing unit
C11 to C13, C21 to C25 counter control unit
K1 to K6, K11 to K13, K21 to K25 connector
L1 to L6, L11 to L13, L21 to L25 bus communication line
N network cable
P1 to P6, P11 to P13, P21 to P25 processor
RU1 to RU3 remote unit
S electric signal line
U1 to U6, U11 to U13, U21 to U25, U31 to U34, U41 to U46 unit
W1 to W6, W11 to W13, W21 to W25 interrupt-signal control unit

1. A sequencer system comprising:
a plurality of units;
a backplane on which the units are mounted;
a bus communication line for data transmission and reception among the units;
a clock generation unit that generates a fixed-cycle clock signal having an arbitrary cycle; and
an electric signal line that is provided separately from the bus communication line, and transfers the fixed-cycle clock signal from the clock generation unit to the units via the backplane, wherein
each of the units includes
a processor that controls the unit, and
an interrupt-signal control unit that generates an interrupt signal corresponding to the fixed-cycle clock signal, and
the processor uses the interrupt signal to synchronize control timings of the units.

2. The sequencer system according to claim 1, wherein
the unit further includes a counter control unit that controls a synchronous counter,
the counter control unit executes zero clear of the synchronous counter depending on the fixed-cycle clock signal, and causes the synchronous counter to count up in a same operating frequency in the respective units, and
the interrupt-signal control unit generates the interrupt signal depending on a value of the synchronous counter.

3. The sequencer system according to claim 1, wherein the clock generation unit is provided in any of a master unit that manages an entire system among the plurality of units, the units other than the master unit, and the backplane.

4. The sequencer system according to claim 1, further comprising a communication-relay processing unit that controls data transmission and reception among the units by relaying, wherein
the communication-relay processing unit is provided in either the units or the backplane.

5. The sequencer system according to claim 1, wherein
the electric signal line transfers the fixed-cycle clock signal to all the units constituting the sequencer system, and
the units can select whether to execute synchronous control by the fixed-cycle clock signal.

6. The sequencer system according to claim 1, further comprising a selector unit that can selectively switch connection and disconnection of the electric signal line, wherein
the clock generation unit is provided in each group acquired by grouping the units by disconnection of the electric signal line in the selector unit.

7. The sequencer system according to claim 6, wherein the clock generation units provided in respective groups acquired by grouping the units generate the fixed-cycle clock signals having a frequency different from each other.

8. The sequencer system according to claim 1, further comprising the electric signal lines, wherein
the units can be grouped by selection of the electric signal lines, and
the clock generation unit is provided in respective groups of the units grouped by the selection of the electric signal lines.

9. The sequencer system according to claim 1, comprising a combination of the backplanes that can be connected to each other directly or via a cable.

10. The sequencer system according to claim 1, wherein the data transmission and reception among the units are performed in a fixed cycle.

11. The sequencer system according to claim 1, wherein
the units include a network unit connected to a remote unit via a network cable, and
the network unit transfers the fixed-cycle clock signal via the network cable.

12. The sequencer system according to claim 1, wherein
the units include a network unit connected to a network via a network cable, and
the network unit transfers the fixed-cycle clock signal to another sequencer system connected to the network, via the network cable.

13. A control method of a sequencer system including
a plurality of units,
a backplane on which the units are mounted, and
a bus communication line for data transmission and reception among the units, wherein the control method comprises:
a step of generating a fixed-cycle clock signal having an arbitrary cycle;
a step of transferring the fixed-cycle clock signal to the units via the backplane, through an electric signal line provided separately from the bus communication line;
a step of generating an interrupt signal corresponding to the fixed-cycle clock signal in the unit; and
a step of using the interrupt signal to synchronize control timings of the units.
